(19) United States
(12) Patent Application Publication
(10) Pub. No.: US 2026/0348292 A1
(43) Pub. Date: Nov. 5, 2026

(54) LABYRINTH SEAL ROTARY SEALING DEVICE

(71) Applicant: SAFRAN AIRCRAFT ENGINES, Paris (FR)

(72) Inventors: Clément Raphaël LAROCHE, Moissy-Cramayel (FR); Stéphane Xavier Gérard ROUSSELIN, Moissy-Cramayel (FR)

(73) Assignee: SAFRAN AIRCRAFT ENGINES, Paris (FR)

(21) Appl. No.: 19/485,972

(22) PCT Filed: Jun. 11, 2024
(86) PCT No.: PCT/FR2024/050757

§ 371 Date: Nov. 19, 2025

(30) Foreign Application Priority Data
Jun. 20, 2023 (FR) FR2306333

(51) Int. Cl. F01D 11/02; F16J 15/447

(52) U.S. Cl. CPC F01D 11/02; F16J 15/447

(57) ABSTRACT

A rotary sealing device including a first element which rotatably mounted about a longitudinal axis relative to a second element, wherein one of the first and second elements includes a seal bearing surface that has a first free end and the other of the first and second elements includes a seal which forms a seal with a first face of the seal bearing surface, the other of the first and second elements also including a portion that includes an outer face opposite an inner face, the inner face extending facing a second face of the seal bearing surface opposite the first face, such that a second free end of the portion has a non-zero offset with the first free end in a direction parallel to the longitudinal axis. A turbine engine can include such a device.

### TECHNICAL FIELD

The invention relates to the field of sealing devices for rotating elements and more particularly to sealing devices with labyrinth seals.

### PRIOR ART

Climate change is a major concern for many legislative and regulatory bodies around the world. Indeed, various restrictions on carbon emissions have been, are, or will be adopted by various states. In particular, an ambitious standard is applied not only to new types of aircraft but also to those in circulation requiring the implementation of technological solutions to make them compliant with the regulations in force. Civil aviation has been taking action for several years now to make a contribution to the fight against climate change.

Technological research efforts have already made it possible to very significantly improve the environmental performance of aircraft. The Applicant considers the factors impacting in all design and development phases to obtain aeronautical components and products that are less energy-consuming, more environmentally friendly and whose integration and use in civil aviation have moderate environmental impacts with the aim of improving the energy efficiency of aircraft.

Consequently, the Applicant is continuously working to reduce its climate impact through the use of methods and the operation of virtuous development and manufacturing processes and by minimizing greenhouse gas emissions to as little as possible to reduce the environmental footprint of its activity. This sustained research and development work covers both the new generations of aircraft engines, the reduction of the weight of aircraft, in particular through the materials used and lighter on-board equipment, the development of the use of electrical technologies to provide propulsion, and, indispensable complements to technological progress, aviation biofuels.

To this end, the invention is the result of technological research aimed at very significantly improving aircraft performance and, accordingly, helps reduce the environmental impact of aircraft. For this purpose, the invention relates to reducing the consumption of lubricating oil and limiting the dispersion of this lubricating oil in the aircraft environment.

Conventionally, a bearing of a rotating element of a turbine engine is lubricated by centrifugal spraying of lubricating oil. The bearings and their sprayed oil cloud are contained in an enclosure which must be sealed, as the lubricating oil may affect the operation of other components of the turbine engine neighboring the enclosure. A rotary sealing device generally comprises a lip seal or a labyrinth seal with knife-edge seals secured to a fixed element and which abuts (lip seal) or is flush relative to a rotating shaft. To limit the amount of oil that the seal must stop, installing a dropper sealing device—or deoiler—near the seal is known. The dropper consists of a radial wall constrained to rotate with the rotating shaft and which centrifugally discharges the oil particles sprayed on the wall to a collector. However, a quantity of oil passes this type of dropper device and enters the labyrinth seal.

When the rotating element stops rotating, the oil droplets in the labyrinth seal run along the parts. If hot parts are touched, they coke, which is detrimental to the operation of the turbine engine.

### OBJECT OF THE INVENTION

The object of the invention is to improve the sealing of a rotary sealing device of the seal type.

### DISCLOSURE OF THE INVENTION

For this purpose, a rotating sealing device is provided comprising a first element mounted for rotation about a longitudinal axis relative to a second element, wherein one of the first and second elements comprises a seal seat having a first free end and the other of the first and second elements comprises a seal which provides a seal with a first face of the seal seat. The other of the first and second elements also comprises a portion comprising an outer face opposite an inner face. The inner face extends facing a second face of the seal seat opposite the first, such that a second free end of the portion has a non-zero offset with the first free end in a direction parallel to the longitudinal axis.

In this way a sealing device is obtained with a baffle that creates an air pressurization zone and, by also reducing the air passage cross-section, improves the efficacy of the seal.

According to other particular, non-exclusive and optional embodiments of the invention:
the outer face forms a first non-zero angle with the longitudinal axis, preferentially a first angle lying between twenty degrees and eighty degrees°;
the first free end comprises a first externally projecting protuberance the vertex of which forms a second acute angle with the longitudinal axis;
the second free end comprises a second externally projecting protuberance that forms a third acute angle with the outer face;
the outer face comprises a plurality of externally projecting teeth;
the portion is connected to the other of the first and second elements by a continuous web that forms a fourth obtuse angle with the longitudinal axis;
the seal is a labyrinth type seal;
the seal is secured to the first element.

The invention also relates to a turbine engine comprising a casing and a first rotary sealing device as described above, wherein a rotor of the turbine engine is connected to the first element and the second element is connected to the casing, the casing accommodating a bearing of the rotor. Optionally, the turbine engine comprises a second rotary sealing device installed so that the first and second rotary sealing devices are located on either side of the bearing.

Other features and advantages of the invention will become apparent upon reading the following description of particular non-limiting embodiments of the invention.

### BRIEF DESCRIPTION OF THE DRAWINGS

Reference will be made to the attached figures, among which:

FIG. 1 is a schematic view in longitudinal section of an aircraft engine;

FIG. 2 is a schematic view in longitudinal section of a shaft provided with a sealing device according to a first embodiment of the invention;

FIG. 3 is a schematic view in longitudinal section of a shaft provided with a sealing device according to a second embodiment of the invention.

### DETAILED DISCLOSURE OF PARTICULAR EMBODIMENTS

In a turbine engine, here a faired turbojet engine referenced 1 in FIG. 1, air is admitted into an inlet duct 2 to pass through a fan comprising a series of rotary blades 3 before splitting into a central primary flow which flows in a so-called flow path of a primary airflow and a secondary flow surrounding the primary flow.

The primary flow is compressed by compressor stages 4 and 5 before reaching a combustion chamber 6, after which it expands by passing through turbines 7, before being discharged while generating a thrust. The secondary flow is for its part propelled directly by the fan to generate the main thrust.

The compressor stages 4 and 5 comprise fixed nozzles evenly spaced around a shaft 8 (not shown in FIG. 1) mounted for rotation about a longitudinal axis AX in a nacelle 9 surrounding the assembly. The blades of the compressor stages 4 and 5 and of the turbines 7 are constrained to rotate with the shaft 8. The shaft 8 is mounted for rotation relative to the nacelle 9 by means of several oil-lubricated bearings 10 which are confined in enclosures 11.

In the present text, the terms “internal” or “inner” and “external” or “outer” are used with reference to the position or orientation relative to the axis of rotation of the turbines of the turbojet engine 1. In the present text the terms “upstream” AM and “downstream” AV are used with reference to the position or orientation of an element in the flow direction of the air in the turbojet engine 1. An axial direction, a radial direction which is orthogonal to the axial direction, and a circumferential direction which is orthogonal to the axial and radial directions, are also defined.

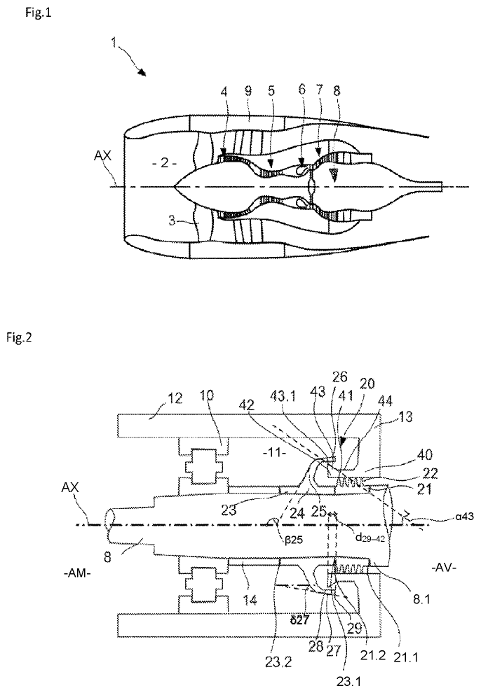

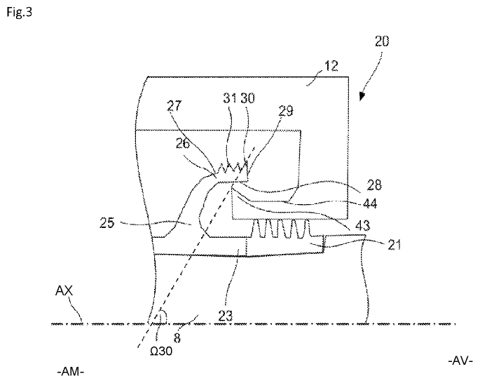

With reference to FIG. 2, the enclosure 11 comprises a casing 12 connected to the nacelle 9. The housing 12 comprises a downstream partition 13 through which the shaft 8 passes and which is fitted with a rotating sealing device 20. The device 20 comprises a labyrinth seal 21 with knife-edge seals 22 known per se and which is mounted clamped on the shaft 8 in order to be constrained to rotate with it. The seal 21 has a downstream face 21.1 that abuts against a shoulder 8.1 of the shaft 8. The knife-edge seals 22 face a seal seat 40 to make a sealed connection with a first face 41 of the seat 40. The seal seat 40 is secured to the casing 12 and extends substantially parallel to the axis Ax from the partition 13 upstream thereof to end in a first free end 42. The free end 42 comprises a first protuberance 43 in external radial projection of the seal seat 40 which connects the face 41 with a second face 44 of the seat 40 opposite the face 41.

The protuberance 43 has a vertex 43.1 which here forms an acute angle α43 with the longitudinal axis Ax. The device 20 also comprises a ring 23 keyed on the shaft 8 and which has a downstream face 23.1 which comes into contact with an upstream face 21.2 of the seal 21.

The ring 23 has an upstream face 23.2 on which a separation spacer 14 is supported with the bearing 10.

The ring 23 comprises a body 24 substantially in the form of a straight cylinder of longitudinal axis Ax and protruding from which a continuous web 25 extends which forms an obtuse angle (β25) with the longitudinal axis Ax. The web 25 connects the body 24 to a portion 26 substantially parallel to the axis Ax and which has an outer face 27 opposite an inner face 28. The inner face 28 extends opposite the face 44 of the seal seat 40. As can be seen in FIG. 2, the second free end 29 of the portion 26 has a non-zero offset distance d29-42 from the first free end 42 in a direction parallel to the longitudinal axis Ax.

In order to facilitate the flow of the oil deposited therein when the rotation of the shaft 8 stops, the outer face 27 forms an angle δ27, here equal to twenty degrees, with the longitudinal axis Ax.

Thus, a sealing device provided with a baffle is obtained which creates an air pressurization zone and, by also reducing the air passage cross-section, improves the efficacy of the seal 21. The selected inclinations of the outer face 27 and of the second face 44 as well as the protuberance 43 and its inclination limit the trickling of the oil towards the seal 21 and therefore also contribute to improving the sealing of the device 20.

Elements that are identical or analogous to those previously described above will bear a reference numeral that is identical thereto in the following description of a second embodiment of the invention.

According to a second embodiment shown in FIG. 3, the second free end 29 comprises a second protuberance 30 projecting externally from the portion 26 and which forms an acute angle Ω30 with the outer face 27. The outer face 27 also comprises a plurality of teeth 31 projecting externally from the portion 26.

According to a third embodiment, not shown, the turbine engine 1 comprises a second rotary sealing device installed so that the first sealing device 20 and the second rotary sealing device are located on either side of the bearing 10.

The angle δ27 constitutes a first angle δ27, the angle α43 constitutes a second angle α43, the angle Ω30 constitutes a third angle Ω30, the angle β25 constitutes a fourth angle β25.

It goes without saying that the invention is not limited to the embodiments described, but encompasses any variant falling within the field of the invention as defined by the claims.

In particular:
although here the seal is secured to the rotating element, the invention also applies to a sealing device wherein the first element comprises the seal seat;
although here the ring is keyed on the shaft, the invention also applies to other types of rotational connection between the shaft and the first element of the Rotary sealing device such as for example a connection by shrinking, gluing or screwing;
although the sealing device herein comprises a labyrinth seal, the invention also applies to other types of seal such as for example a lip-type rotary seal;
although the aircraft engine is faired here, the invention also applies to a non-faired engine (also called “Open Fan”)
although here the outer face of the portion forms an angle of twenty degrees with the longitudinal axis, the invention also applies to other non-zero values of first angle such as for example an angle greater than zero degrees and less than ninety degrees, preferably an angle between twenty degrees and eighty degrees.

1. A rotary sealing device comprising a first element mounted rotatably about a longitudinal axis relative to a second element, wherein one of the first and second elements comprises a seal seat having a first free end and the other of the first and second elements comprises a seal that makes the seal with a first face of the seal seat the other of the first and second elements also comprising a portion including an outer face opposite an inner face the inner face extending directly facing a second face of the seal seat opposite to the first face such that a second free end of the portion has a non-zero offset with the first free end in a direction parallel to the longitudinal axis, and
wherein the outer face forms a first non-zero angle with the longitudinal axis, preferentially a first angle lying between twenty degrees and eighty degrees.

2. The rotary sealing device according to claim 1, wherein the first free end comprises a first protuberance projecting externally and the vertex of which forms a second acute angle with the longitudinal axis.

3. The rotary sealing device according to claim 1, wherein the second free end comprises a second externally projecting protuberance that forms a third acute angle with the outer face.

4. The rotary sealing device according to claim 1, wherein the outer face comprises a plurality of teeth protruding externally.

5. The rotary sealing device according to claim 1, wherein the portion is connected to the other of the first and second elements by a continuous web that forms a fourth obtuse angle with the longitudinal axis.

6. The rotary sealing device according to claim 1, wherein the seal is a labyrinth type seal.

7. The rotary sealing device according to claim 1, wherein the seal is secured to the first element.

8. A turbine engine comprising a casing and a first rotary sealing device according to claim 1, wherein a rotor of the turbine engine is connected to the first element and the second element is connected to the casing the casing accommodating a bearing of the rotor.

9. The turbine engine according to claim 8, comprising a second rotary sealing device, wherein the second rotary sealing device is installed such that the first sealing device and the second rotary sealing device are located on either side of the bearing.
